(19) United States
(12) Patent Application Publication
(10) Pub. No.: US 2016/0337039 A1
(43) Pub. Date: Nov. 17, 2016

(54) OPTICAL TRANSMITTING DEVICE AND OPTICAL RECEIVING DEVICE

(71) Applicant: FUJITSU LIMITED, Kawasaki-shi (JP)

(72) Inventors: GUOXIU HUANG, Inagi (JP); Yasuhiko Aoki, Yokohama (JP); Shoichiro Oda, Fuchu (JP)

(73) Assignee: FUJITSU LIMITED, Kawasaki-shi (JP)

(21) Appl. No.: 15/135,815

(22) Filed: Apr. 22, 2016

(30) Foreign Application Priority Data
May 12, 2015 (JP) 2015-097241

(51) Int. Cl. H04B 10/516; H04B 10/60; H04J 14/02; H04B 10/564

(52) U.S. Cl. CPC H04B 10/516; H04B 10/564; H04B 10/60; H04J 14/021

(57) ABSTRACT

An optical transmitting device includes: an optical modulator configured to modulate light output from a light source with a drive signal generated by controlling a frequency of a first signal based on a second signal; and an amplitude controller configured to control amplitude of the first signal based on a control signal, wherein signal light modulated by the optical modulator is transmitted to an optical receiving device.

### CROSS-REFERENCE TO RELATED APPLICATION

This application is based upon and claims the benefit of priority of the prior Japanese Patent Application No. 2015-097241, filed on May 12, 2015, the entire contents of which are incorporated herein by reference.

### FIELD

The embodiments discussed herein are related to an optical transmitting device and an optical receiving device.

### BACKGROUND

One of optical communication techniques is to superimpose a signal, which is different from a main signal, on main signal light through frequency modulation. For example, a signal for monitoring or control of an optical transmission system may be superimposed onto main signal light through frequency modulation.

The related techniques are disclosed in, for example, Japanese Laid-open Patent Publications No. 2013-9238 and No. 2000-31900.

### SUMMARY

According to an aspect of the invention, an optical transmitting device includes: an optical modulator configured to modulate light output from a light source with a drive signal generated by controlling a frequency of a first signal based on a second signal; and an amplitude controller configured to control amplitude of the first signal based on a control signal, wherein signal light modulated by the optical modulator is transmitted to an optical receiving device.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating a configuration example of an optical transmission system according to one embodiment;

FIGS. 2A and 2B are diagrams illustrating an example of superimposing a wavelength path trace signal onto main signal light through frequency modulation;

FIG. 3 is a diagram illustrating an example of detection of a wavelength path trace signal superimposed onto main signal light through frequency modulation;

FIG. 4 is a block diagram illustrating a configuration example that focuses on a reconfigurable optical add/drop multiplexer (ROADM) exemplarily illustrated in FIG. 1;

FIGS. 5A and 5B are diagrams illustrating an example of a relationship (with no offset) of permeability characteristics of a wavelength-selective switch (WSS) exemplarily illustrated in FIG. 4 and a main signal light spectrum onto which a frequency-modulated signal is superimposed;

FIGS. 6A and 6B are diagrams illustrating an example of a relationship (with offset) of the permeability characteristics of the wavelength-selective switch exemplarily illustrated in FIG. 4 and the main signal light spectrum onto which the frequency-modulated signal is superimposed;

FIG. 7 is a diagram illustrating an example in which power variation occurs in main signal light due to gain variation in the optical amplifier exemplarily illustrated in FIG. 4;

FIG. 8 is a block diagram illustrating a configuration example of an optical transmission system to which offset amplitude modulation according to one embodiment is applied;

FIGS. 9A and 9B are diagrams illustrating inversion characteristics of power variation that occurs in the main signal light in the optical transmission system exemplarily illustrated in FIG. 8;

FIG. 10 is a flowchart illustrating an operation example of the optical transmission system exemplarily illustrated in FIG. 8;

FIG. 11 is a block diagram illustrating a first configuration example of a superimposed signal transmitter exemplarily illustrated in FIG. 8;

FIG. 12 is a block diagram illustrating the first configuration example of the superimposed signal transmitter exemplarily illustrated in FIG. 8;

FIG. 13 is a diagram illustrating an example of a path trace signal generated by a path trace signal generator exemplarily illustrated in FIG. 11 and FIG. 12;

FIG. 14 is a flowchart illustrating an operation example of the superimposed signal transmitter exemplarily illustrated in FIG. 11 and FIG. 12;

FIG. 15 is a block diagram illustrating a second configuration example of the superimposed signal transmitter exemplarily illustrated in FIG. 8;

FIG. 16 is a block diagram illustrating a third configuration example of the superimposed signal transmitter exemplarily illustrated in FIG. 8;

FIG. 17 is a block diagram illustrating a first configuration example of a superimposed signal detector exemplarily illustrated in FIG. 8;

FIG. 18 is a flowchart illustrating an operation example of the superimposed signal detector exemplarily illustrated in FIG. 17;

FIGS. 19A and 19B are diagrams for explaining that the superimposed signal transmitter exemplarily illustrated in FIG. 8 may transmit a head code during a non-transmission period of a path trace signal;

FIG. 20 is a block diagram illustrating a second configuration example of the superimposed signal detector exemplarily illustrated in FIG. 8; and

FIG. 21 is a flowchart illustrating an operation example of the superimposed signal detector exemplarily illustrated in FIG. 20.

### DESCRIPTION OF EMBODIMENTS

In an optical transmission system, when main signal light passes through an optical component such as a wavelength-selective switch (WSS) or an optical amplifier, power variation (which may also be referred to as an “amplitude modulation (AM) component”) may occur in the main signal light, depending on characteristics of the optical component.

Power variation in main signal light may act as a noise component of a signal superimposed onto the main signal light (which may be referred to as a “superimposed signal” for convenience). This may deteriorate transmission performance of a superimposed signal. The transmission performance of the superimposed signal is related to reception characteristics (in other words, reception quality) of the superimposed signal.

An embodiment of an optical transmitting device and an optical receiving device that may improve the transmission performance of a superimposed signal is described hereinafter with reference to the drawings. However, embodiments to be described below are simply exemplary and not intended to exclude application of a variety of variations or techniques that are not clearly described below. In addition, various types of exemplary aspects described below may also be carried out in combination appropriately. Note that in the drawings used in the following embodiments, parts allocated with identical symbols represent identical or similar parts unless otherwise noted.

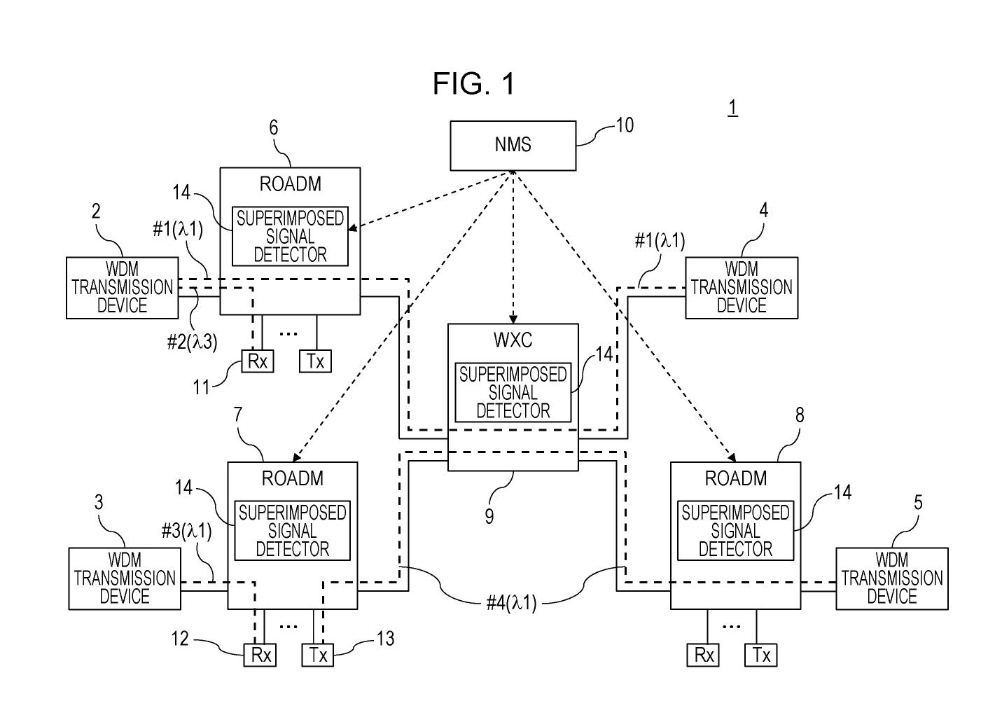

FIG. 1 is a block diagram illustrating a configuration example of an optical transmission system according to one embodiment. An “optical transmission system” may also be referred to as a “photonic network”. An optical transmission system 1 illustrated in FIG. 1 may exemplarily include WDM transmission devices 2 to 5, reconfigurable optical add/drop multiplexers (ROADMs) 6 to 8, a wavelength cross connect (WXC) 9, and a network management system (NMS) 10.

Note that “WDM” is an abbreviation for “Wavelength Division Multiplex”. “ROADM” is an abbreviation for “Reconfigurable Optical Add/Drop Multiplexer”. “WXC” is an abbreviation for “Wavelength Cross Connect”. “WXC” may also be referred to as a photonic cross connect (PXC).

Any of the WDM transmission devices 2 to 5, the ROADMs 6 to 8, and the wavelength cross connect 9 is an example of an “optical transmitting device”. An “optical transmitting device” may be referred to as a “station” or a “node”. In addition, an NMS 10 may also be referred to as an “operating system (OPS) 10”.

The WDM transmission devices 2, 3, and 5 may be connected to the ROADMs 6, 7, and 8, respectively, via optical transmission lines. An “optical transmission line” may be an “optical fiber transmission line” using an optical fiber.

The ROADMs 6, 7, and 8 may each be connected to the wavelength cross connect 9 via the optical transmission line. The WDM transmission device 4 may be connected to the wavelength cross connect 9 via the optical transmission line. Note that one or more optical amplifier may be appropriately provided for each optical transmission line.

The WDM transmission devices 2 to 5 may transmit a WDM signal light including signal light of multiple wavelengths (which may also be referred to as a “channel”) to the optical transmission line. The WDM transmission devices 2 to 5 may also receive WDM signal light from the optical transmission line.

The ROADMs 6 to 8 may allow a channel specified from channels included in the WDM signal light received from the optical transmission line to pass to the optical transmission line. The ROADMs 6 to 8 may also branch to an optical receiver (Rx) any signal light of a channel included in WDM signal light received from the optical transmission line. “Branching” of signal light may be referred to as “drop” and the dropped signal light may be referred to as “drop light”.

Drop light is demodulated at the optical receiver and may be transmitted to a client network. A “client network” may also be referred to as a “tributary network”. A signal that is transmitted through the client network may also be referred to as a client signal.

A client network may be a synchronous digital network such as a synchronous digital hierarchy (SDH) or a synchronous optical network (SONET), or Ethernet®.

Furthermore, the ROADMs 6 to 8 may insert signal light received from an optical transmitter (Tx) into WDM signal light transmitted to the optical transmission line. “Insertion” of signal light into WDM signal light may be referred to as “add” and signal light to be “added” to the WDM signal light may be referred to as “add light”. “Add light” may exemplarily be a modulated signal light which is transmission light modulated by the optical transmitter with a client signal.

The wavelength cross connect 9 includes multiple input ports and multiple output ports, and direct signal light received at any of the input ports to any of the output ports, so as to implement a specified optical path. Note that the wavelength cross connect 9 may also be provided with a function to branch or insert signal light (add/drop function), similar to the ROADMs 6 to 8.

The NMS 10 sets an optical path instructed by, for example, an operator in the optical transmission system 1. Exemplarily, the NMS 10 may control the WDM transmission devices 2 to 5, the ROADMs 6 to 8, and the wavelength cross connect 9 so as to implement an optical path instructed by the operator.

In the example illustrated in FIG. 1, optical paths #1 to #4 are set for the optical transmission system 1. Each optical path is respectively depicted by a dotted line. Exemplarily, the optical path #1 may transmit signal light from the WDM transmission device 2 to the WDM transmission device 4 via the ROADM 6 and the wavelength cross connect 9.

The optical path #2 may exemplarily transmit signal light from the WDM transmission device 2 to an optical receiver 11 via the ROADM 6. The optical path #3 may exemplarily transmit signal light from the WDM transmission device 3 to an optical receiver 12 via the ROADM 7.

The optical path #4 may transmit signal light from the optical transmitter 13 to the WDM transmission device 5 via the ROADM 7, the wavelength cross connect 9, and the ROADM 8. Note that in some or all of the optical paths #1 to #4, signal light may be transmitted in both directions

According to the photonic network 1, for example, at any ROADMs 6 to 8, signal light of desired wavelength may be dropped from WDM signal light and guided to a client network or a client signal of any wavelength may be inserted into WDM signal light. In addition, rather than converting the received WDM signal light into an electric signal, the wavelength cross connect 9 may directly control a transmission route as light in the unit of wavelength.

Incidentally, in the photonic network 1 using the ROADMs 6 to 8 or the wavelength cross connect 9, a same wavelength (stated differently, a same frequency grid) may be set for different optical paths. An optical path may exemplarily set by the NMS 10.

As illustrated in FIG. 1, for example, the NMS 10 may allocate wavelengths λ1, λ3, λ1, and λ1 to the optical paths #1, #2, #3, and #4, respectively. For example, an operator may check whether or not these wavelengths are handled and switched or routed without error.

However, when the same wavelength is allocated to multiple optical paths, each individual optical path may not be distinguished by simply monitoring a spectrum of a channel. For example, in the wavelength cross connect 9, even if light spectra of different optical paths #1 and #4 to which the same wavelength λ1 is allocated are monitored, the optical paths #1 and #4 may not be distinguished.

Thus, the NMS 10 may assign each optical path with information by which the optical path may be identified. Information by which the optical path may be identified may also be referred to as a “path identifier (path ID)” or a “label”.

An optical transmitting device corresponding to a transmission source of an optical path may superimpose a signal indicative of a path ID to signal light that is transmitted to the optical path. A signal indicative of a path ID may also be referred to a “wavelength path trace signal” or simply a “path trace signal”.

A “path trace signal” may also be taken as an example of a signal for confirming conductivity of an optical path. A “path trace signal” may also be referred to as a “superimposed signal” or a “sub-signal” to a main signal.

A “superimposed signal” or a “sub-signal” may also be taken as an example of a “supervisory (SV) signal”. Note that a signal (or information) superimposed onto signal light is not limited to a path trace signal. Some control signal or notice signal or the like, which is different from a main signal, may be superimposed onto signal light. Exemplarily, a superimposed signal may be superimposed onto signal light with a frequency modulation (FSK: Frequency Shift Keying) scheme.

Through FSK, the WDM transmission device 2 may superimpose a signal representing “path ID=1” onto signal light of a wavelength λ1 to be transmitted to the optical path #1 and superimpose a signal representing “path ID=2” onto signal light of a wavelength λ3 to be transmitted to the optical path #2 through FSK.

The optical transmitting devices 6 to 9 through which any optical path passes may be provided with a superimposed signal detector 14 in a receiving system, the superimposed signal detector 14 detecting a path trace signal superimposed onto received signal light to detect a path ID.

The superimposed signal detector 14 may be reworded by a “path trace signal detector 14”. When a path trace signal is superimposed onto signal light using the FSK scheme, the superimposed signal detector 14 may also be taken as an example of an FSK signal detector.

Note that some or all of the optical transmitting devices 6 to 9 may be provided with the superimposed signal detector 14 or any one of the optical transmitting devices 6 to 9 may be provided with multiple superimposed signal detectors 14.

In addition, the superimposed signal detector 14 may be built in the optical transmitting devices 6 to 9 or detachably connected to the optical transmitting devices 6 to 9. The WDM transmission devices 2 to 5 may be provided with the superimposed signal detector 14.

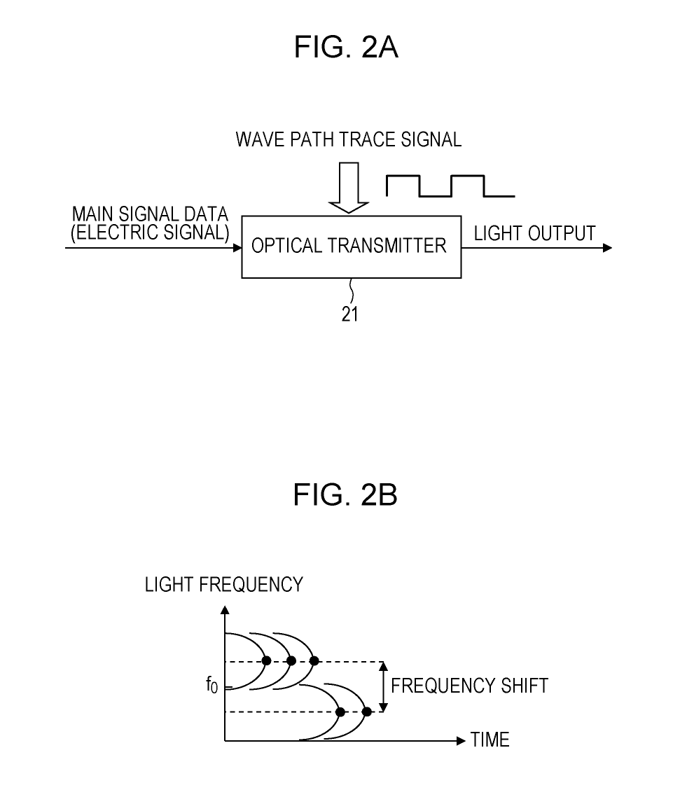

FIG. 2A is a block diagram illustrating an example of an optical transmitter 21 capable of superimposing a frequency-modulated (FSK) signal onto a main signal. Any of the WDM transmission devices 2 to 5 exemplarily illustrated in FIG. 1 may be provided with the optical transmitter 21. In addition, the optical transmitter 21 may correspond to the optical transmitter 13 exemplarily illustrated in FIG. 1.

As exemplarily illustrated in FIG. 2A, the optical transmitter 21 may superimpose a path trace signal onto a main signal as an FSK signal by performing FSK on the main signal, which is an electric signal, according to the path trace signal.

A path trace signal may be a tone signal or a code signal, which has a lower speed than a main signal. Exemplarily, a path trace signal may be a sinusoidal signal.

With superimposition of an FSK signal, as exemplarily illustrated in FIG. 2B, an output light spectrum of the optical transmitter 21 varies (which may also be referred to as a “frequency shift”) in a frequency axis direction, depending on time change.

A path trace signal superimposed onto a main signal may be detected by the superimposed signal detector 14 detecting time variation of frequency shift.

As described below, time change of frequency shift may be detected by using a light filter to convert variation in the frequency axis direction to a change in light power.

Superimposition onto a main signal of a path trace signal having different frequency components for every optical path enables an individual optical path to be identified even if a same wavelength is allocated to the individual optical path.

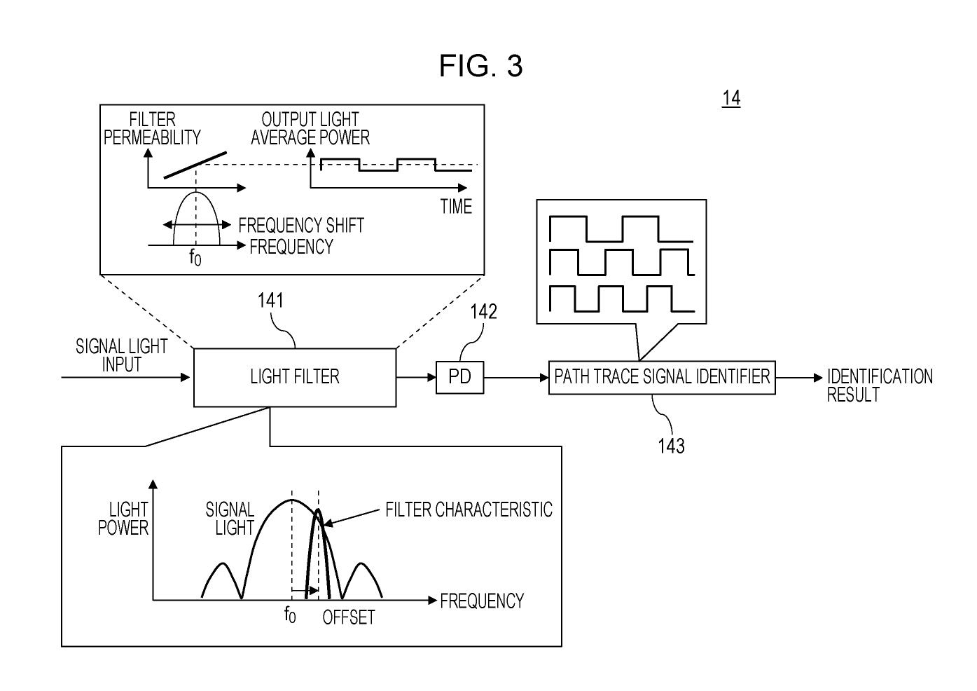

FIG. 3 illustrates a configuration example of the superimposed signal detector 14. The superimposed signal detector (path trace signal detector) 14 illustrated in FIG. 3 may exemplarily include a light filter 141, a photodetector or photodiode (PD) 142, and a path trace signal identifier 143.

The PD 142 outputs a photocurrent that corresponds to the power of light which is received through the light filter 141.

Here, when the PD 142 receives WDM signal light onto which an FSK signal is superimposed through the light filter 141, power variation corresponding to a frequency of a superimposed signal occurs in a photocurrent outputted from the PD 142.

For example, here assume that “f₀” denotes the center frequency of carrier light transmitted by the optical transmitter 21, “+Δf” denotes one of values of a binary FSK signal, and “−Δf” denotes the other value of the binary FSK signal.

In this case, a main signal light spectrum onto which the FSK signal is superimposed cyclically frequency-shifts between “+Δf” and “−Δf” centering around the center frequency f₀. A frequency shift amount “Δf” may be adequately lower than a frequency of the carrier light. For example, for WDM signal light for which a channel is arranged in a frequency grid of 50 GHz or 100 GHz, “Δf” may be on the order of 1 MHz to 1 GHz.

On the other hand, in the superimposed signal detector 14, as exemplarily illustrated in FIG. 3, the light filter 141 may be set for a frequency whose pass-band center frequency is offset from the center frequency f₀ of the carrier light.

In addition, transmission bandwidth of the light filter 141 is set to bandwidth at which a main signal light spectrum partially permeates and may be exemplarily set to narrower bandwidth than half of bandwidth of the entire main signal light spectrum.

With settings of the filter characteristics described above, a difference is created in power of light that permeates the light filter 141 between when the main signal light spectrum is frequency-shifted only by “+Δf” and when the main signal light spectrum is frequency-shifted only by “−Δf”.

Therefore, a change in power corresponding to a frequency of a superimposed signal appears in an output photocurrent of the PD 142. Stated differently, time change in frequency shift is converted into power change.

Therefore, the output photocurrent of the PD 142 includes a signal waveform corresponding to a frequency component of a superimposed signal.

If multiple superimposed signals are superimposed onto WDM signal light, the output photocurrent of the PD 142 may include multiple signal waveforms corresponding to frequency components of the multiple superimposed signals.

By identifying power variation in an output photocurrent of the PD 142, the path trace signal identifier 143 may identify an optical path trace signal superimposed onto received WDM signal light.

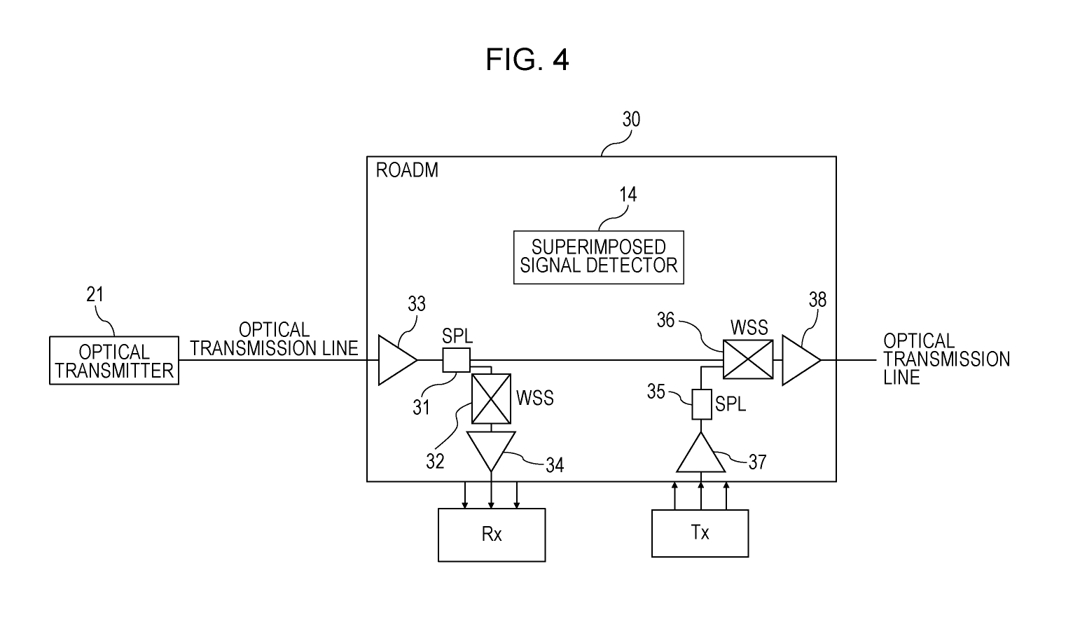

Then, FIG. 4 illustrates a configuration example that focuses on an add function and a drop function of a ROADM 30. The ROADM 30 exemplarily illustrated in FIG. 4 may be any of the ROADMs 6 to 8 exemplarily illustrated in FIG. 1.

As exemplarily illustrated in FIG. 4, the ROADM 30 may include an optical splitter (SPL) 31 and a wavelength-selective switch (WSS) 32 as an example of the drop function. Received WDM signal light is branched by the optical splitter 31 and inputted to the WSS 32 which then selects signal light of a wavelength that directs to the optical receiver Rx.

Note that an optical amplifier 33 configured to amplify received WDM signal light may be appropriately provided in a previous stage of the optical splitter 31. The optical amplifier 33 may be reworded by a preamplifier 33 or a receiving amplifier 33. In addition, an optical amplifier 34 may also be provided appropriately in a back stage of the WSS 32. The optical amplifier 34 amplifies drop light of the wavelength selected by the WSS 32.

In addition, the ROADM 30 may include an optical splitter 35 and a WSS 36 as an example of the add function. Add light transmitted by the optical transmitter Tx is guided to the WSS 36 through the optical splitter 35. Then, the add light is inserted into the WDM signal light by being selectively outputted together with the wavelength included in the WDM signal light that passes through the optical splitter 31.

Note that an optical amplifier 37 configured to amplify add light may be appropriately provided in a front stage of the optical splitter 35. An optical amplifier 38 may also be provided appropriately in a back stage of the WSS 36. The optical amplifier 38 may be reworded by a post-amplifier 38 or a transmitting amplifier 38.

If the WSS (32 or 36) is used for the drop function or the add function of the ROADM 30 as described above, power variation may be generated in main signal light due to permeability characteristics (which may be referred to as “WSS permeability characteristics”) that the WSS has.

For example, if a binary FSK signal is superimposed onto main signal light, the main signal light includes frequency components of two patterns of a pattern #1 and a pattern #2.

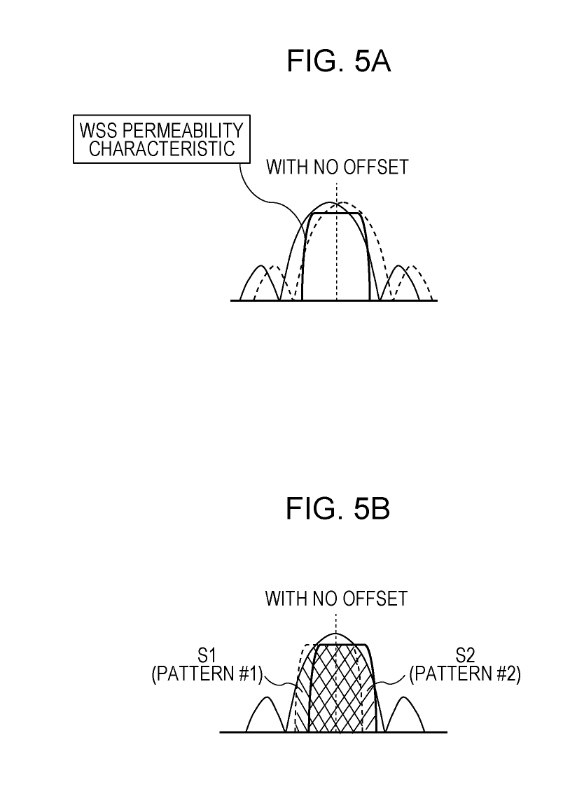

Here, as exemplarily illustrated in FIG. 5A, suppose that there is no offset between a center frequency of the WSS permeability characteristics and a center frequency of main signal light onto which an FSK signal is superimposed.

In this case, as illustrated by a solid line and a dotted line in FIG. 5A, even if a main signal light spectrum varies in the frequency axis direction depending on a frequency component of a superimposed signal, the variation may be symmetrical with respect to the center frequency of the WSS permeability characteristics.

Therefore, the power of main signal light that permeates the WSS (which may be referred to as “WSS transmitted light power” for convenience) does not change in the binary patterns #1 and #2 of the superimposed signal or a change, if any, may be at a negligible level.

For example, in FIG. 5B, area S1 of a region depicted by a solid diagonal line is equivalent to, for example, WSS transmitted light power that corresponds to the pattern #1 and area S2 of a region depicted by dotted diagonal line is equivalent to WSS transmitted light power that corresponds to the other pattern #2.

The area S1 and the area S2 do not change because variation is symmetrical with respect to the center frequency of the WSS permeability characteristics even if a main signal light spectrum varies in the frequency axis direction depending on the frequency component of the superimposed signal. Therefore, there is no substantial change in the WSS transmitted light power in the pattern #1 and the pattern #2.

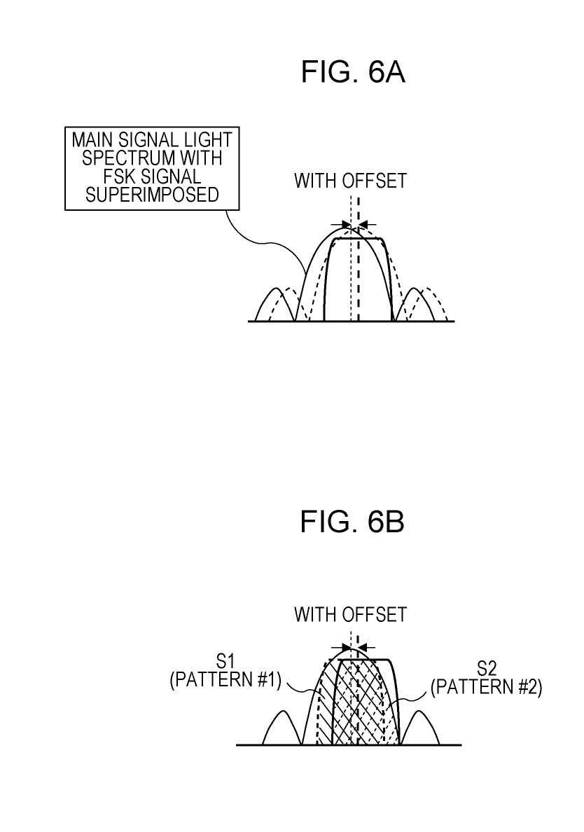

In contrast to this, as exemplarily illustrated in FIG. 6A, if there if offset between a center frequency of the WSS permeability characteristics and a center frequency of main signal light onto which an FSK signal is superimposed, a difference is created between the area S1 and the area S2 as exemplarily illustrated in FIG. 6B.

Therefore, variation occurs in the WSS transmitted light power between the pattern #1 and the pattern #2. Consequently, power variation occurs in the main signal light. Stated differently, occurrence of power variation in main signal light means that an amplitude modulation (AM component) appears in the main signal light. Power variation (AM component) of main signal light is noise to a superimposed signal.

In addition, exemplarily, power variation in main signal light may also be generated due to occurrence of gain variation caused by mutual gain modulation in an optical amplifier provided in an optical transmission line.

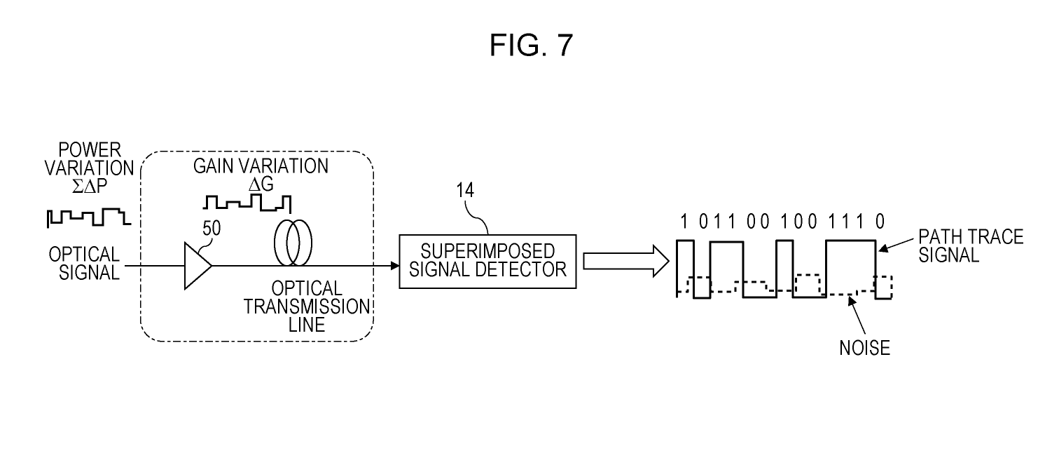

As illustrated in FIG. 7, for example, if variation (ΣΔP) occurs in input light power of an optical amplifier 50, gain variation (ΔG) occurs in the optical amplifier 50 depending on the power variation. Power variation occurs in the main signal light depending on the gain variation and the power variation is noise to the superimposed signal.

Then, in an embodiment described below, power variation (AM component) that occurs in main signal light is detected on the receiving side and amplitude of an FSK signal superimposed onto the main signal light is controlled on the transmitting side so that the detected power variation is offset or reduced. The control of amplitude may be referred to as “offset amplitude modulation” for convenience.

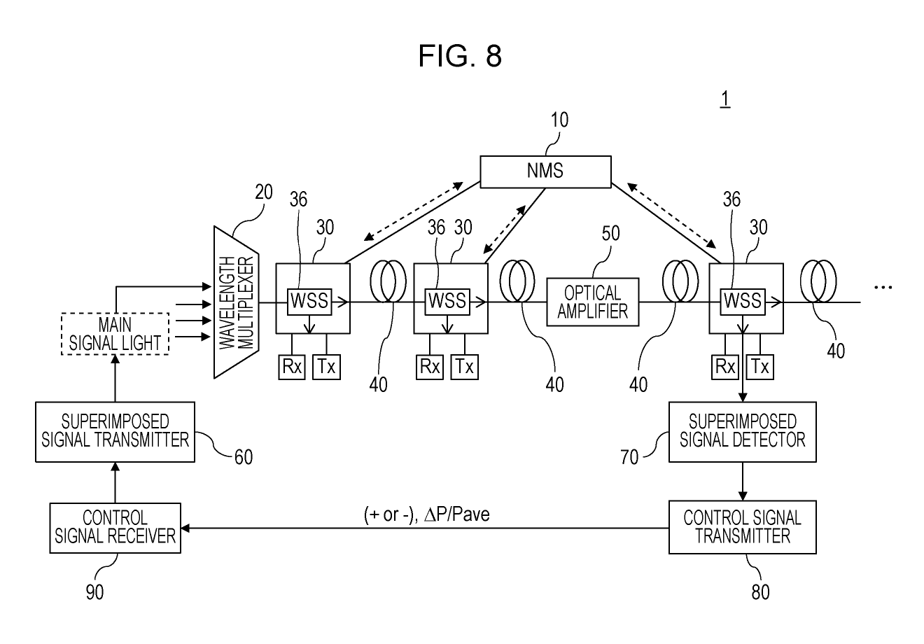

FIG. 8 illustrates a configuration example of an optical transmission system 1 to which “offset amplitude modulation” is applied. Exemplarily, the optical transmission system 1 illustrated in FIG. 8 may be a WDM optical transmission system, and may include multiple nodes 30, an optical amplifier 50, a superimposed signal transmitter 60, a superimposed signal detector 70, a control signal transmitter 80, and a control signal receiver 90.

Each of the nodes 30 may be intensively managed and controlled by the NMS 10 which was already described. The superimposed signal transmitter 60 may be taken as an example of an optical transmitter or an optical transmitting device. The superimposed signal detector 70 may be taken as an example of an optical receiver or an optical receiving device. The superimposed signal detector 70 may correspond to any of the superimposed signal detectors 14 exemplarily illustrated in FIG. 1.

The nodes 30 may be connected to each other by optical transmission lines 40. The optical transmission line 40 of any of the nodes 30 may be provided with one or more optical amplifier 50. WDM signal light transmitted to the optical transmission line 40 may be generated by a wavelength multiplexer 20.

The superimposed signal transmitter 60 may superimpose a path trace signal onto main signal light wavelength multiplexed by the wavelength multiplexer 20, through FSK. Note that the wavelength multiplexer 20 may be included in a node 30 that is a transmission source of WDM signal light. A node 30 that is a transmission source of WDM signal light may be referred to as a “transmitting node 30” for convenience.

The transmitting node 30 may be provided with the superimposed signal transmitter 60 and the control signal receiver 90. On the other hand, a receiving node 30 may be provided with the superimposed signal detector 70 and the control signal transmitter 80. The receiving node 30 may correspond to a node 30 that receives any of wavelengths included in the WDM signal light.

Each of the nodes 30 may have a configuration exemplarily illustrated in FIG. 4. For convenience, FIG. 8 illustrates the WSS 36 that constitutes the add function exemplarily illustrated in FIG. 4. The WSS 36 is an example of a WSS provided in a light path by which main signal light is transmitted, in the node 30.

The superimposed signal transmitter 60 may exemplarily superimpose a path trace signal onto main signal light through FSK scheme. In addition, the superimposed signal transmitter 60 may exemplarily control the amplitude of the path trace signal to be superimposed onto the main signal.

The control of amplitude may be exemplarily implemented so that power variation in main signal light detected at the superimposed signal detector 70 is offset or reduced. As already described, power variation of main signal light may occur because main signal light passes through one or more WSS 36 or optical amplifier 50.

Amplitude of the path trace signal superimposed onto main signal light by the superimposed signal transmitter 60 may be controlled with a control signal so that the power variation in the main signal light is offset or reduced. The control may also be referred to as “feedback control”.

A control signal may be exemplarily generated and transmitted (fed back) to the control signal receiver 90 by the control signal transmitter 80. A control signal may include information detected by the superimposed signal detector 70 or information generated based on the detected information. The information may also be referred to as “feedback information”. An example of a control signal (feedback information) is described below.

A communication path through which a control signal is transmitted from the control signal transmitter 80 to the control signal receiver 90 may be an optical communication path or an electric communication path. Exemplarily, the communication path may be an optical transmission line that transmits light in a direction from the node 30 provided with the superimposed signal detector 70 to the node 30 provided with the superimposed signal transmitter 60.

For example, the control signal transmitter 80 may be an optical transmitter configured to transmit light to the optical transmission line and the control signal receiver 90 may be an optical receiver configured to receive light from the optical transmission line.

Similar to the superimposed signal transmitter 60, the optical transmitter as the control signal transmitter 80 may superimpose a control signal onto main signal light through FSK. Similar to the superimposed signal detector 70, the optical receiver as the control signal receiver 90 may detect a control signal superimposed onto the main signal light through FSK.

In addition, a communication path through which a control signal is transmitted may be a communication path via the NMS 10. For example, the control signal transmitter 80 may transmit a control signal to the NMS 10. The control signal receiver 90 may receive a control signal from the NMS 10.

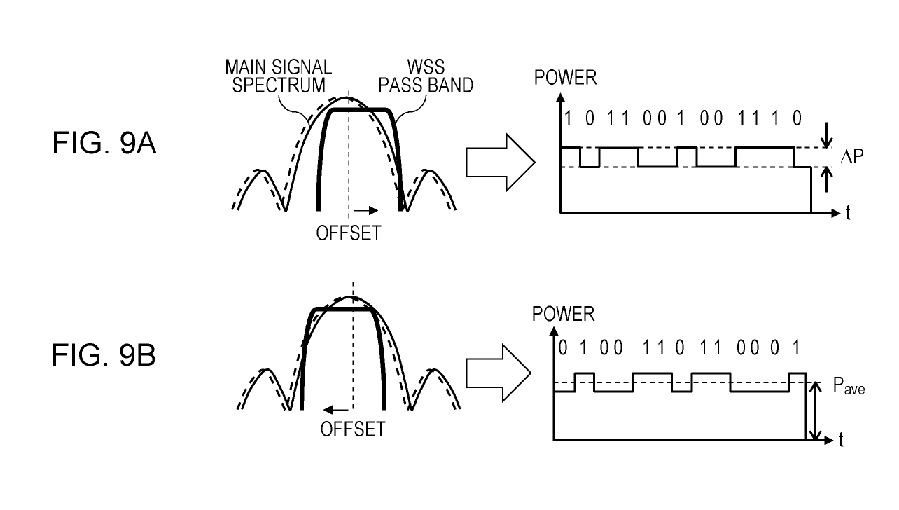

Inversion characteristics of power variation that may occur in main signal light is described hereinafter with reference to FIGS. 9A and 9B.

FIG. 9A exemplarily illustrates an example of power variation that occurs in main signal light if a center frequency of a WSS transmission band is offset to the high frequency side with respect to a center frequency of a main signal light spectrum.

As exemplarily illustrated on the left side of FIG. 9A, if the main signal light spectrum varies to the frequency axis direction depending on an FSK superimposed signal with the center frequency of the WSS transmission band offset to the high frequency side, the power variation (ΔP) as exemplarily illustrated on the right side of FIG. 9A occurs in the main signal light.

For example, if the main signal light spectrum shifts to the high frequency side only by “+Δf” at certain timing of t1, light power that permeates the WSS transmission band depending on the shift increases.

On the other hand, if the main signal light spectrum shifts to the low frequency side only by “−Δf” at subsequent timing of t2 (t2>t1), the light power that permeates the WSS transmission band depending on the shift decreases. If such “increase” and “decrease” in the main signal light power are respectively expressed by “1” and “0”, power variation corresponding to the FSK superimposed signal appears in the main signal light as exemplarily illustrated on the right side of FIG. 9A.

In contrast to this, contrary to the case in FIGS. 9A, FIG. 9B illustrates an example of power variation generated in main signal light if the center frequency of the WSS transmission band is offset to the lower frequency side with respect to the center frequency of the main signal light spectrum.

As exemplarily illustrated on the left side of FIG. 9B, if the main signal light spectrum varies to the frequency axis direction depending on the FSK superimposed signal with the center frequency of the WSS transmission band offset to the low frequency side, power variation as exemplarily illustrated on the right side of FIG. 9B occurs in the main signal light.

For example, if the main signal light spectrum shifts to the high frequency side only by “+Δf” at certain timing of t1, contrary to the case of FIG. 9A, light power that permeates the WSS transmission band depending on the shift decreases.

On the other hand, if the main signal light spectrum shifts to the low frequency side only by “−Δf” at subsequent timing of t2, contrary to the case of FIG. 9A, the light power that permeates the WSS transmission band depending on the shift increases.

More specifically, as may be easily understood from a comparison of FIGS. 9A and 9B, when an offset direction of the center frequency of the WSS transmission band to the center frequency of the main signal light spectrum is reversed, power variation appearing in the main signal light is inverted.

Therefore, an offset direction of the center frequency of the WSS transmission band may be detected by detecting whether power variation of the main signal light is “inverted” or “not inverted” with respect to the FSK superimposed signal. Exemplarily, “not inverted” may be depicted by “positive (+)” and “inverted” may be depicted by “negative (−)”.

A symbol depicting “not inverted” or “inverted” (which may also be referred to as a “logical value”) may be included in a control signal transmitted from the control signal transmitter 80 to the control signal receiver 90. In addition, information indicating a power variation amount (ΔP) of main signal light may be included in a control signal together with a logical value. The information indicating the power variation amount may be exemplarily expressed by a proportion (ΔP/Pave) of the power variation amount (ΔP) to average power (Pave) of main signal light.

When receiving a control signal including the above-mentioned logical value and the information indicating the power variation amount from the control signal transmitter 80, the control signal receiver 90 provides the superimposed signal transmitter 60 with the control signal.

The superimposed signal transmitter 60 controls a waveform of a path trace signal superimposed onto main signal light through FSK based on the received control signal, so that the power variation amount detected by the superimposed signal detector 70 is offset or reduced.

The waveform control of a path trace signal may be exemplarily amplitude control of a path trace signal. The amplitude control may include control that inverts positive or negative of amplitude depending on the logical value described above.

As a result of amplitude of a path trace signal superimposed onto main signal light through FSK being controlled, a frequency and amplitude of the main signal light is controlled.

Therefore, the superimposed signal transmitter 60 may be taken to control a frequency (or phase) and amplitude of main signal light to transmit, so that the power variation amount detected by the superimposed signal detector 70 is offset or reduced.

For example, if a logical value indicating an offset direction is negative (“inverted”), a phase of a path trace signal is inverted and amplitude of the path trace signal is controlled so that a power variation amount of main signal light is offset or reduced.

If the logical value indicating the offset direction is positive (“not inverted”), a waveform (phase) of the path trace signal is not inverted and the amplitude of the path trace signal is controlled so that the power variation amount of the main signal light is offset or reduced.

In this manner, the superimposed signal transmitter 60 performs frequency modulation based on a path trace signal and offset amplitude modulation based on the path trace signal and a control signal on main signal light to transmit.

Note that setting may be such that a control signal is transmitted from the control signal transmitter 80 to the control signal receiver 90 only if a power variation amount in main signal light exceeds a threshold.

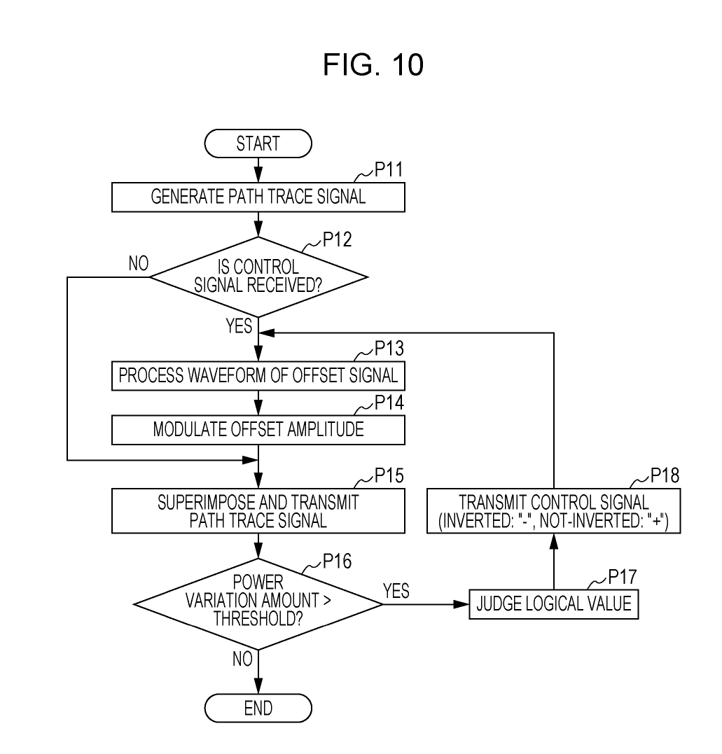

FIG. 10 is a flowchart illustrating an operation example of the WDM optical transmission system 1 exemplarily illustrated in FIG. 8.

As exemplarily illustrated in FIG. 10, the superimposed signal transmitter 60 generates a path trace signal (operation P11). If a control signal is not received from the control signal receiver 90 (No in operation P12), the superimposed signal transmitter 60 may superimpose the path trace signal onto main signal light and transmit the path trace signal (operation P15).

If a control signal is received from the control signal receiver 90 (Yes in operation P12), the superimposed signal transmitter 60 controls phase inversion or non-inversion of the path trace signal based on the control signal, as already described (operations P13 and P14).

In this manner the path trace signal whose phase inversion or non-inversion is controlled depending on a control signal is superimposed to the main signal light and transmitted (operation P15). This offsets or reduces power variation in the main signal light onto which the path trace signal is superimposed.

Until the superimposed signal detector 70 determines in operation P16 that the power variation amount of the main signal light is equal to or smaller than a threshold (No), the superimposed signal transmitter 60 controls the phase and the amplitude of the path trace signal superimposed onto the main signal light. Stated differently, “offset amplitude modulation” based on a control signal is implemented.

The superimposed signal detector 70 detects the power variation amount (AM components) of the received main signal light and determines whether or not the power variation amount exceeds the threshold (operation P16).

If the power variation amount of the main signal light exceeds the threshold (Yes in operation P16), the superimposed signal detector 70 determines a logical value indicating “not inverted” or “inverted” as already described (operation P17). The determined logical value is exemplarily given to the control signal transmitter 80 together with the power variation amount.

The control signal transmitter 80 generates a control signal including a logical value and information indicating a power variation amount and transmits (feeds back) the control signal to the control signal receiver 90 (operation P18). The control signal receiver 90 provides the superimposed signal transmitter 60 with the control signal received from the control signal transmitter 80.

Until a control signal is no longer received (until No is determined in operation P12), the superimposed signal transmitter 60 implements “offset amplitude modulation” and transmits main signal light (operations P13 to P15).

If the power variation amount of the main signal light converges to the threshold or less (No in operation P16), the feedback control of “offset amplitude modulation” based on the control signal ends.

In addition, it is not desirable that a path trace signal is transmitted at all times and there may be a period of time during which no path trace signal is transmitted. As described below, during a non-transmission period of a path trace signal, a probe signal having a specific pattern or code may be superimposed onto main signal light.

Alternatively, ahead of transmission of main signal light, probe signal light that is transmission light modulated by a probe signal may be transmitted alone from the superimposed signal transmitter 60. A period during which probe signal light is transmitted ahead of transmission of main signal light is also an example of non-transmission period of a path trace signal.

As described below, a probe signal may be used in the superimposed signal detector 70 for determination (which may also be referred to as “detection”) of a logical value indicating “not inverted” and “inverted” as already described.

### FIRST CONFIGURATION EXAMPLE OF THE SUPERIMPOSED SIGNAL TRANSMITTER 60

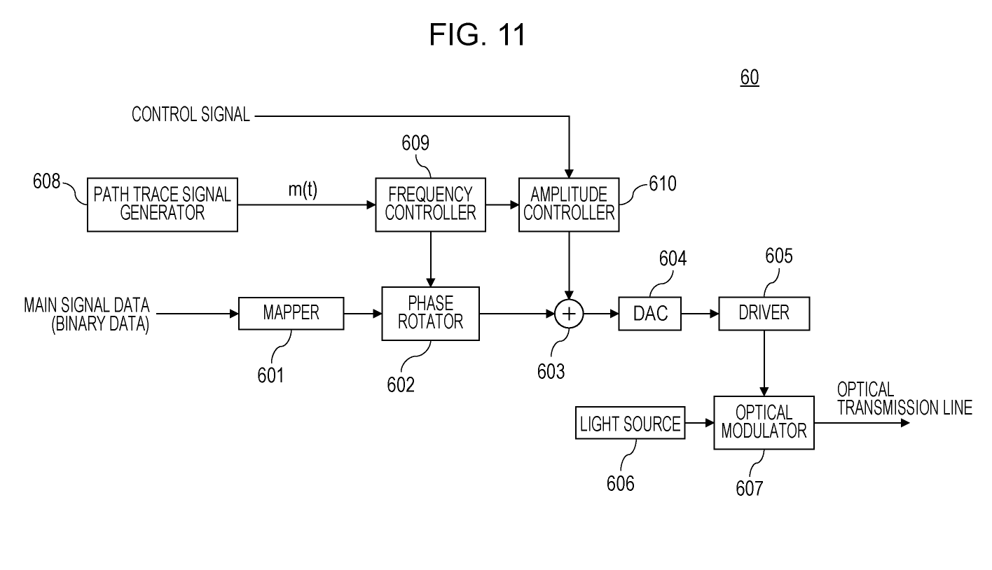

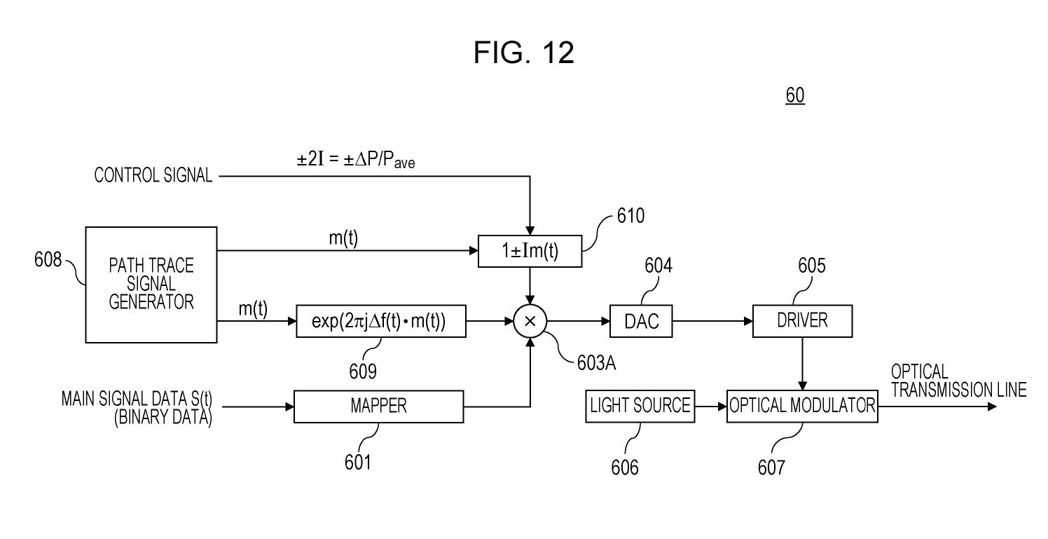

FIGS. 11 and 12 illustrate a configuration example of the superimposed signal transmitter 60 described above. As illustrated in FIG. 11, the superimposed signal transmitter 60 may exemplarily include a mapper 601, a phase rotator 602, and an adder 603, a digital-analog converter (DAC) 604, a driver 605, a light source 606, and an optical modulator 607. The superimposed signal transmitter 60 may also include a path trace signal generator 608, a frequency controller 609, and an amplitude controller 610.

The mapper 601 maps main signal data to transmit (exemplarily, binary data) to a transmission symbol corresponding to a modulation scheme.

A transmission symbol is expressed by an in-phase (I) component and a quadrature (Q) component in a complex plane. A modulation scheme may be quadrature phase shift keying (QPSK) or quadrature amplitude modulation (QAM).

The phase rotator 602 exemplarily rotates a phase of a transmission symbol depending on control of the frequency controller 609. Phase rotation (stated differently, frequency) being controlled depending on a path trace signal, the transmission symbol is frequency-modulated depending on the path trace signal.

Main signal data is an example of a first signal and a path trace signal is an example of a second signal. As described above, a frequency of the first signal is controlled by the frequency controller 609 and the phase rotator 602 based on the second signal.

The adder 603 controls amplitude of the transmission symbol by adding an amplitude control value from the amplitude controller 610 to an amplitude value of the phase-rotated transmission symbol. Stated differently, the transmission symbol is amplitude-modulated by the amplitude controller 610.

The DAC 604 converts a transmission symbol, which is an example of a transmission digital signal, to an analog signal.

The driver 605 generates a drive signal appropriate for driving the optical modulator 607 based on an output analog signal of the DAC 604. The driver 605 may be, for example, an electric amplifier that amplifies an output analog signal of the DAC 604 to an appropriate drive voltage.

The light source 606 outputs transmission light. A semiconductor laser diode (LD) may be applied to the light source 606. An emission wavelength of the LD may be fixed or variable. An LD with variable emission wavelength may be referred to as a “tunable LD”.

The optical modulator 607 modulates output light of the light source 606 depending on a drive signal provided by the driver 605.

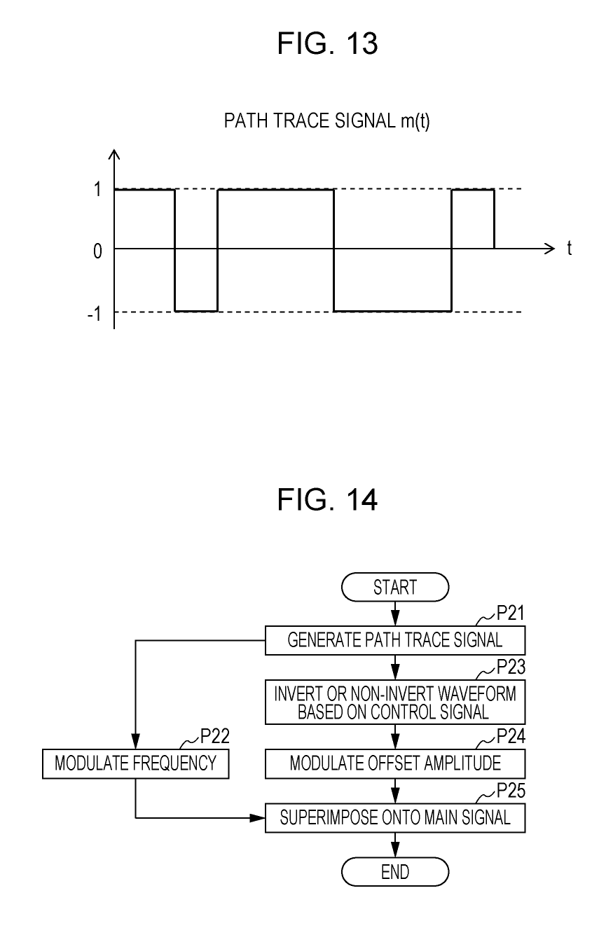

The path trace signal generator 608 generates a path trace signal m(t) (operation P21 of FIG. 14). The path trace signal m(t) may be exemplarily a code signal that takes either “+1” and “−1”, depending on a change in time (t), as illustrated in FIG. 13. Stated differently, m(t) is a time function that takes a value ranging from “−1 to +1” depending on the time change.

Note that the path trace signal generator 608 may be capable of generating any signal having a waveform corresponding to any other specific pattern or code, not limited to a path trace signal. Therefore, the path trace signal generator 608 may also be referred to as a waveform generator 608.

A signal having a waveform corresponding to a specific pattern or a code may be a probe signal. The NMS 10 may exemplarily control whether or not the path trace signal generator 608 generates a path trace signal or a signal having other specific waveform.

The frequency controller 609 controls phase rotation at the phase rotator 602 depending on a path trace signal m(t). As illustrated in FIG. 12, for example, the frequency controller 609 provides a transmission symbol with a phase rotation amount expressed by exp(2πjΔf(t)/m(t)). Note that Δf(t) represents maximum frequency deviation of a path trace signal superimposed onto main signal light through FSK.

The amplitude controller 610 controls amplitude of a transmission symbol by providing the adder 603 with an amplitude control value corresponding to a control signal provided from the control signal receiver 90. As illustrated in FIG. 12, for example, the amplitude controller 610 provides the transmission symbol with an amplitude control value expressed by “1±I/m(t)”.

“I” represents an amplitude value that satisfies “±2I=±ΔP/Pave” and exemplarily corresponds to a logical value indicating whether a symbol (positive or negative) of “ΔP/Pave” is “not inverted” (+1) or “inverted” (−1). Therefore, the amplitude controller 610 controls “not inverted” and “inverted”, and the amplitude value of the path trace signal m(t), depending on a control signal.

In addition, in FIG. 12, a multiplier 603A multiplies the transmission symbol by the phase rotation amount “exp(2πjΔf(t)/m(t))” and the amplitude control value “1±I/m(t)”. The configuration example of FIG. 12 indicates that control of the phase and the amplitude of the transmission symbol may be equivalently implemented by one multiplier 603A in place of the adder 603.

The transmission symbol being multiplied by the phase rotation amount “exp(2πjΔf(t)/m(t))”, a path trace signal is superimposed onto the transmission symbol, which is a main signal (operations P22 and P25 in FIG. 14). In addition, the transmission symbol being multiplied by the amplitude control value “1±I/m(t)” corresponding to “not inverted” or “inverted”, presence or absence of phase “inverted” and the amplitude of the transmission symbol are controlled (operations P23 to P25 of FIG. 14).

In addition, the optical modulator 607 may be driven by a probe signal in place of the path trace signal m(t). For example, the optical modulator 607 being driven by a probe signal during a non-transmission period of the path trace signal m(t), the probe signal may be superimposed onto main signal light and (or the probe signal alone) transmitted.

Since the phase rotator 602 and the amplitude controller 610 respectively control a phase and amplitude of a path trace signal, provision of one waveform generator 608 is sufficient in the superimposed signal transmitter 60.

In addition, since a path trace signal whose phase and amplitude are thus controlled is used for a drive signal of the optical modulator 607, one optical modulator 607 may superimpose a path trace signal onto main signal light as well as perform offset amplitude modulation.

Therefore, scale or cost of the superimposed signal transmitter 60 may be reduced.

### SECOND CONFIGURATION EXAMPLE OF THE SUPERIMPOSED SIGNAL TRANSMITTER 60

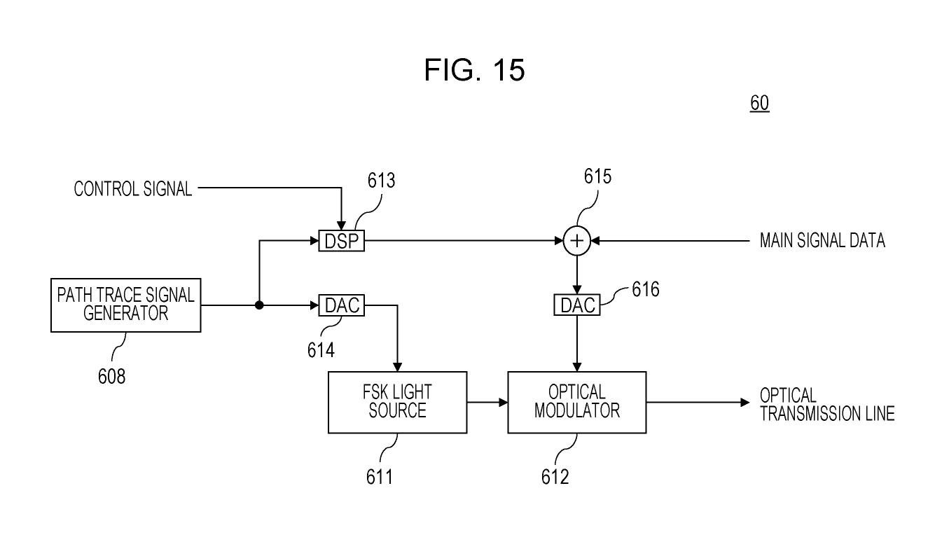

FIG. 15 is a block diagram illustrating a second configuration example of the superimposed signal transmitter 60 described above. The superimposed signal transmitter 60 illustrated in FIG. 15 may exemplarily include a path trace signal generator 608, an FSK light source 611, an optical modulator 612, a digital signal processor (DSP) 613, a DAC 614, an adder 615, and a DAC 616.

In the second configuration example of FIG. 15, the FSK light source 611 is driven with an analog signal converted by the DAC 614 from a path trace signal generated by the path trace signal generator 608. With this, output light of the FSK light source 611 is directly frequency-modulated according to the path trace signal.

The frequency-modulated light that is outputted from the FSK light source 611 is inputted to the optical modulator 612. The optical modulator 612 is provided with an analog signal converted from main signal data by the DAC 616 as a drive signal.

Therefore, the optical modulator 612 further modulates the frequency-modulated light with the drive signal corresponding to the main signal data. With this, the optical modulator 612 outputs main signal light onto which the path trace signal is superimposed through FSK.

The “offset amplitude modulation” may be exemplarily carried out by the DSP 613 and the adder 615. For example, the DSP 613 generates an amplitude control value of a path trace signal, according to a control signal received by the control signal receiver 90.

The adder 615 adds the generated amplitude control value to main signal data used in a drive signal of the optical modulator 612. The optical modulator 612 being driven with the drive signal to which the amplitude control value is added, the optical modulator 612 carries out the “offset amplitude modulation” based on the path trace signal and the control signal.

In this manner, the offset amplitude modulation may also be carried out using digital signal processing by the DSP 613. Third configuration example of the superimposed signal transmitter 60

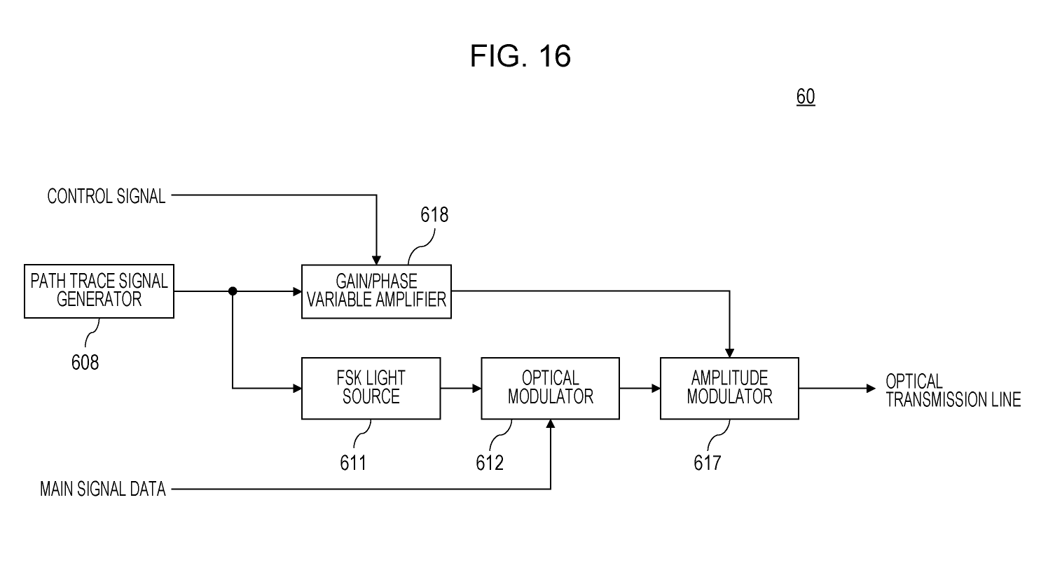

FIG. 16 is a block diagram illustrating a third configuration example of the superimposed signal transmitter 60 described above. The superimposed signal transmitter 60 illustrated in FIG. 16 may exemplarily include a path trace signal generator 608, an FSK light source 611, an optical modulator 612, an amplitude modulator 617, and a gain/phase variable amplifier 618.

The gain/phase variable amplifier 618 is an example of an amplifier capable of adjusting amplification gain and a phase of an input signal (for example, a path trace signal) depending on a control signal.

In the third configuration example of FIG. 16, the “offset amplitude modulation” is exemplarily carried out by the amplitude modulator 617 and the gain/phase variable amplifier 618.

For example, according to information indicating a power variation amount which is included in a control signal received by the control signal receiver 90, gain of the gain/phase variable amplifier 618 is controlled and amplitude of a path trace signal is controlled.

In addition, according to a logical value indicating “inverted” or “not inverted” included in the control signal received by the control signal receiver 90, inversion and non-inversion of an output phase of the gain/phase variable amplifier 618 is controlled, and inversion and non-inversion of a path trace signal waveform is controlled.

The amplitude modulator 617 being driven by using an output signal of the gain/phase variable amplifier 618 for a drive signal, output light of the optical modulator 612 is further modulated. Similar to the second configuration example of FIG. 15, the optical modulator 612 further modulates frequency-modulated light, which is the output light of the FSK light source 611 driven with the path trace signal, with a drive signal corresponding to main signal data.

Therefore, the amplitude modulator 617 performs the “offset amplitude modulation” on the main signal light, which is outputted from the optical modulator 612, and has the path trace signal superimposed thereon, by using, as a drive signal, a signal obtained by the gain/phase variable amplifier 618 controlling the waveform of a path trace signal.

### FIRST CONFIGURATION EXAMPLE OF THE SUPERIMPOSED SIGNAL DETECTOR 70

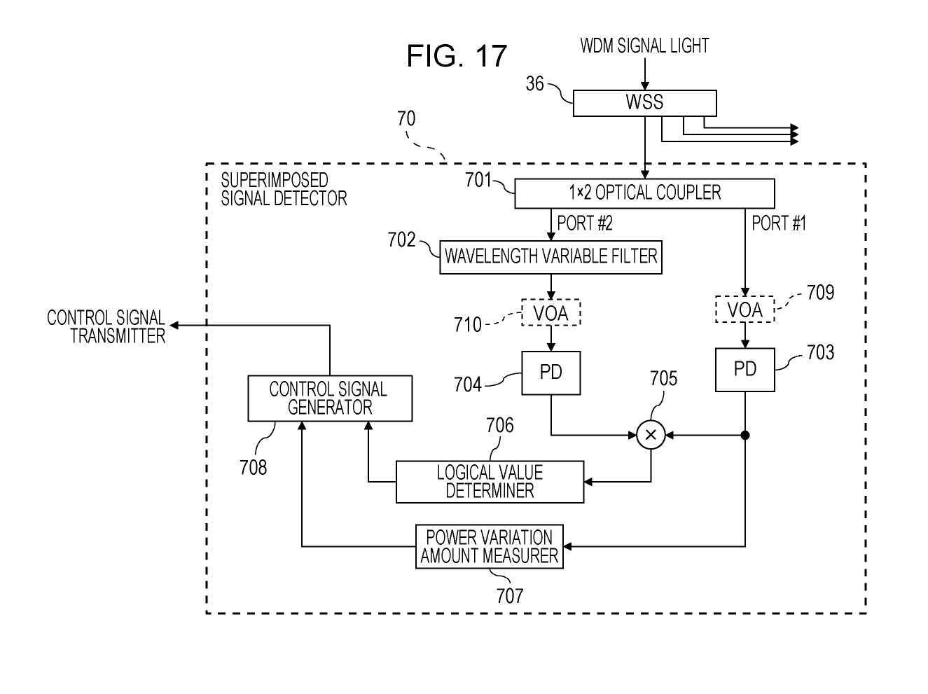

FIG. 17 is a block diagram illustrating a first configuration example of the superimposed signal detector 70 described above. The superimposed signal detector 70 illustrated in FIG. 17 may exemplarily include a 1×2 optical coupler 701, a wavelength variable filter 702, PDs 703 and 704, a mixer 705, a logical value determiner 706, a power variation amount measurer 707, and a control signal generator 708. “PD” is an abbreviation for a photodetector or a photodiode.

The 1×2 optical coupler 701 branches into two main signal light that permeates the WSS 36, and outputs the branched lights to two output ports #1 and #2.

Light outputted from the first output port #1 is guided to the first PD 703 and light outputted from the second output port #2 is guided to the wavelength variable filter 702.

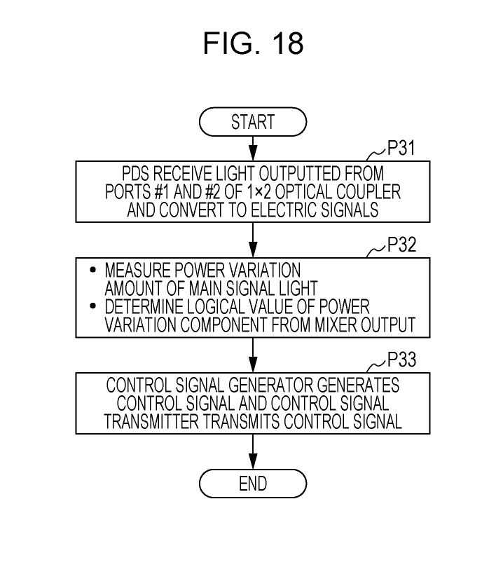

The first PD 703 receives the light outputted from the first output port #1 of the 1×2 optical coupler 701 and outputs an electric signal having amplitude corresponding to light receiving power of the first PD 703 (operation P31 of FIG. 18).

The first PD 703 receives main signal light without (stated differently, bypassing) the wavelength variable filter 702.

A power variation component (AM component) generated by the main signal light passing through the WSS 36 or the optical amplifier 50 appears in an electric signal outputted from the first PD 703.

The wavelength variable filter 702 partially filters the light outputted from the second output port #2 of the 1×2 optical coupler 701.

The wavelength variable filter 702 may be equivalent to the light filter 141 exemplarily illustrated in FIG. 3 and similar to the light filter 141, a pass-band center frequency and transmission bandwidth may be set.

For example, a pass-band center frequency of the wavelength variable filter 702 may be set to a frequency off from a center frequency f₀ of carrier light. In addition, the transmission bandwidth of the wavelength variable filter 702 may be set to narrower bandwidth than half of bandwidth of a main signal light spectrum.

With such filter settings, as already described in FIG. 3, a spectrum of the received main signal light may be converted to light power variation corresponding to a path trace signal superimposed onto the main signal light through FSK. Light that permeates the wavelength variable filter 702 is guided to the second PD 704.

Note that the wavelength variable filter 702 is an example of a light filter. Making the pass-band center frequency of the wavelength variable filter 702 variable (which may also be referred to as “sweep”) enables detection of a path trace signal in the unit of a wavelength included in WDM signal light.

The second PD 704 receives the light that permeates the wavelength variable filter 702 and outputs an electric signal having amplitude corresponding to light receiving power of the second PD 704 (operation P31 of FIG. 18).

Stated differently, the second PD 704 receives main signal light via the wavelength variable filter 702 and outputs a signal corresponding to power of the received light. An electric signal outputted from the second PD 704 is a signal including an amplitude component of a path trace signal.

Note that a variable optical attenuator (VOA) 709 may be appropriately provided in a light path from the first output port #1 of the 1×2 optical coupler 701 to the PD 703. The VOA 709 may adjust the input light level to the first PD 703.

In addition, a VOA 710 may also be appropriately provided in a light path from the wavelength variable filter 702 to the second PD 704. The VOA 710 may adjust the input light level to the second PD 704.

An attenuation amount (which may also be referred to as “VOA loss”) of the VOAs 709 and 710 may be controlled so that the levels of input light to the PDs 703 and 704 may be within receivable ranges of the PDs 703 and 704.

The VOA loss may be controlled by a controller built in a superimposed signal detector 17 or a controller built in the node 30 provided with the superimposed signal detector 17, or may be controlled by the NMS 10. Note that illustration of a controller is omitted in FIG. 17.

The mixer 705 mixes output electric signals of the PDs 703 and 704. The mixing may be multiplication.

The power variation amount measurer 707 measures a power variation amount of an output electric signal of the first PD 703 (operation P32 of FIG. 18). The power variation amount of the output electric signal of the first PD 703 represents a power variation amount of main signal light. Therefore, the power variation amount measurer 707 may be taken as an example of a first detector that detects a power variation amount of signal light based on an output signal of the first PD 703.

As already described in FIGS. 9A and 9B, based on an output electric signal of the mixer 705, the logical value determiner 706 determines whether an AM component of main signal light is “inverted” or “not-inverted” with respect to an amplitude component of a path trace signal superimposed on the main signal light through FSK (operation P32 of FIG. 18).

The logical value determiner 706 may be taken as an example of a second detector that detects a symbol indicating whether the path trace signal is inverted or not inverted to the power variation of the main signal light, based on an output signal of the PDs 703 and 704.

The control signal generator 708 generates a control signal including a logical value determined by the logical value determiner 706 and information indicating a power variation amount measured by the power variation amount measurer 707. The generated control signal is outputted to the control signal transmitter 80 and transmitted (fed back) from the control signal transmitter 80 to the control signal receiver 90 (operation P33 of FIG. 18).

The logical value determiner 706, the power variation amount measurer 707, and the control signal generator 708 enable reliable generation of a control signal that the superimposed signal transmitter 60 uses to control amplitude of a path trace signal.

### SECOND CONFIGURATION EXAMPLE OF THE SUPERIMPOSED SIGNAL DETECTOR 70

As already described, if a non-transmission period of a path trace signal is present, main signal light onto which a probe signal is superimposed or probe signal light that modulates transmission light with a probe signal may be transmitted alone from the superimposed signal transmitter 60.

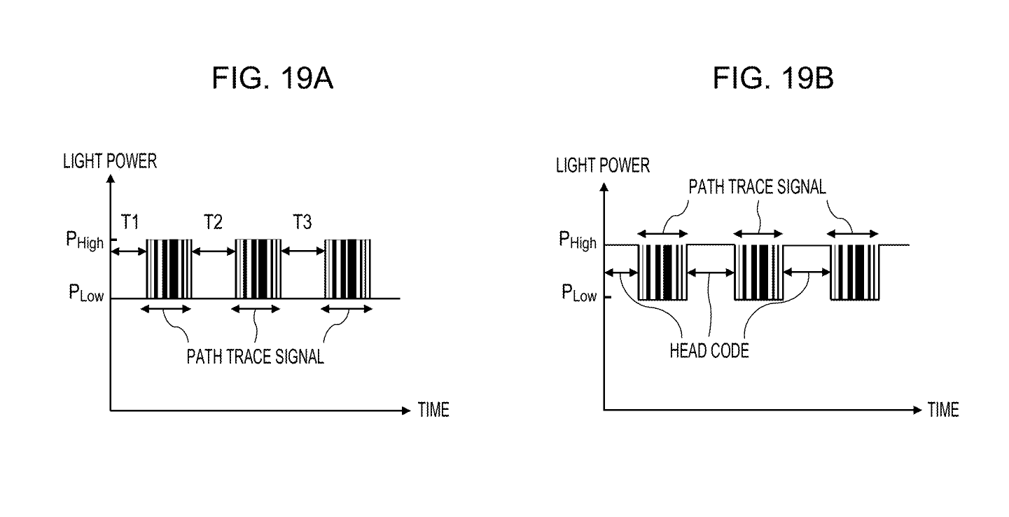

For example, as illustrated in FIG. 19A, if periods T1, T2, and T3 during which no path trace signal is transmitted are present, a probe signal may be transmitted in any of the periods T1, T2, and T3 as illustrated in FIG. 19B.

A specific pattern or code may be used for a probe signal. For example, a code that may represent “inverted” or “not inverted” with a 8-bit complement may be used for a probe signal. A code of a probe signal that is transmitted ahead of transmission of main signal light may also be referred to as a “head code”.

Exemplarily, a head code of “00111100” may represent “ non-inversion” and a head code “11000011”, which is a complement of the head code, may represent “inversion”. In addition, a head code all of 8 bits of which are 0 (or 1) may represent “not inverted” and a head code all bits of which are 1 (or 0), which is a complement of the head code, may represent “inverted”.

If such a probe signal is transmitted from the superimposed signal transmitter 60, the logical value determiner 706 may determine a logical value based on an output signal of the second PD 704 even if the logical value determiner 706 does not use an output signal of the first PD 703.

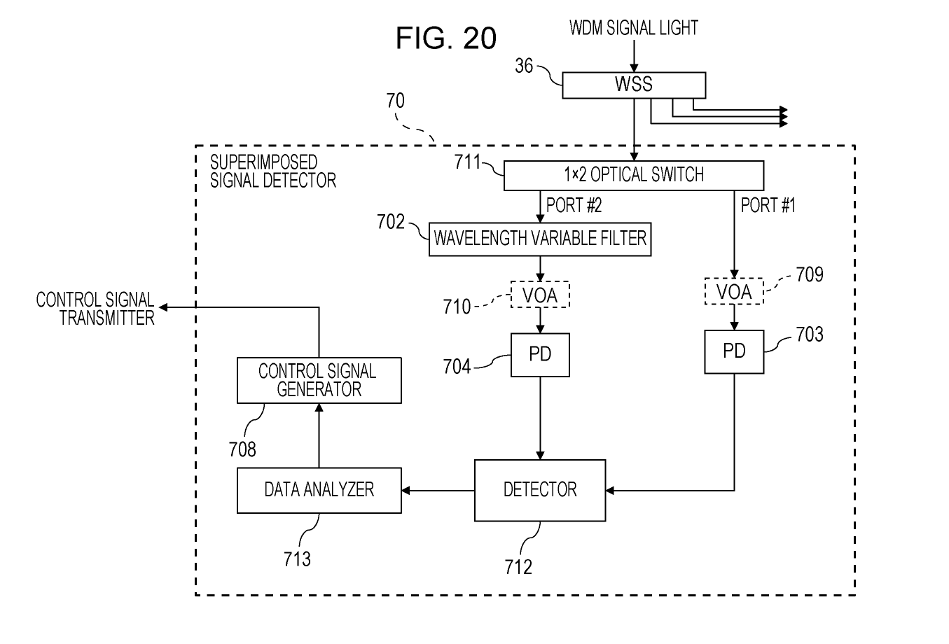

Thus, the superimposed signal detector 70 may have the second configuration example illustrated in FIG. 20, for example. Compared with the first configuration example of FIG. 17, the superimposed signal detector 70 exemplarily illustrated in FIG. 20 is different in that the 1×2 optical coupler 701 is replaced by a 1×2 optical coupler 711 and that the logical value determiner 706 and the power variation amount measurer 707 are replaced by a detector 712. In addition, compared with the first configuration example, the second configuration example is different in that the mixer 705 is no desirable and that a data analyzer 713 is added.

The 1×2 optical switch 711 may selectively output main signal light that permeates the WSS 36 to any one of the two output ports #1 and #2. The selective output may be exemplarily controlled by the NMS 10.

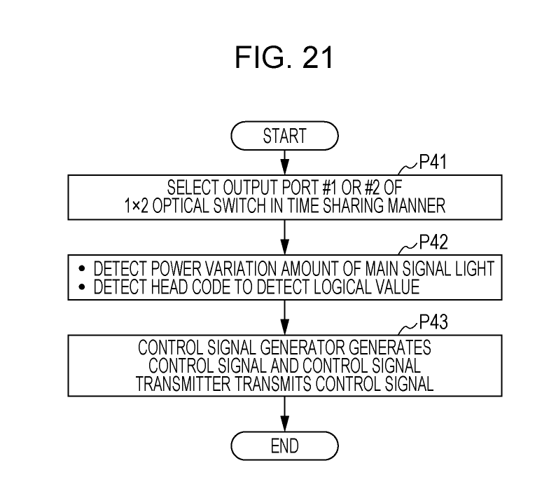

For example, the output port #1 is selected for an output destination of received main signal light in a non-transmission period of a path trace signal (transmission period of a probe signal), and the output port #2 is selected for an output destination of received main signal light in a transmission period of a path trace signal (operation P41 of FIG. 21).

In the transmission period of a path trace signal, the detector 712 detects the path trace signal based on an electric signal having amplitude corresponding to light receiving power at the PD 704. In the non-transmission period of the path trace signal, a power variation amount and a probe signal are detected based on the electric signal having the amplitude corresponding to the light receiving power at the PD 703.

In this manner, the detector 712 detects a path trace signal and detects a power variation amount and a probe signal in a time multiplexing manner, depending on switching of the output ports of the 1×2 optical switch 711 (operation P42 of FIG. 21).

The data analyzer 713 analyzes the data detected in a time multiplexed manner by the detector 712 while temporarily storing the data in a storage (illustration omitted), and generates information indicating power variation amount of the main signal light and a logical value indicated by a probe signal as an analysis result.

The analysis result is provided to the control signal generator 708. The control signal generator 708 generates a control signal including an analysis result. The generated control signal is outputted to the control signal transmitter 80 and transmitted (fed back) from the control signal transmitter 80 to the control signal receiver 90 (operation P43 of FIG. 21).

As described above, the superimposed signal detector 70 detects power variation that occurs depending on a characteristic of an optical component as main signal light permeates the optical component such as the WSS 36 or the optical amplifier 50. Then, based on the detection result, the superimposed signal transmitter 60 controls amplitude of a signal superimposed onto main signal light through FSK to amplitude for which power variation detected on the receiving side is offset or suppressed.

Therefore, the transmission performance of a signal (exemplarily, a path trace signal) superimposed onto main signal light through FSK may be improved and the reception characteristics of a superimposed signal may be improved.

Since the reception characteristics of the superimposed signal may be improved, a possible transmission distance of a superimposed signal may be extended, for example, even when main signal light is transmitted through multiple nodes 30 and passes through the WSS 36 or the optical amplifier 50 in multiple stages.

Since the possible transmission distance of the superimposed signal may be extended, restriction of the transmission distance of the main signal light by the possible transmission distance of the superimposed signal may be avoided or controlled.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An optical transmitting device comprising:
an optical modulator configured to modulate light output from a light source with a drive signal generated by controlling a frequency of a first signal based on a second signal; and
an amplitude controller configured to control amplitude of the first signal based on a control signal,
wherein signal light modulated by the optical modulator is transmitted to an optical receiving device.

2. The optical transmitting device according to claim 1,
wherein the control signal includes information indicating power variation of the signal light received by the optical receiving device, the power variation being detected by the optical receiving device, and
wherein the amplitude controller controls amplitude of the first signal based on the information indicating the power variation so that the power variation is suppressed.

3. The optical transmitting device according to claim 2,
wherein the information indicating the power variation includes a symbol indicating whether or not the second signal is inverted in accordance with the power variation of the signal light, and
wherein the amplitude controller inverts or does not invert a waveform of the second signal depending on the symbol.

4. The optical transmitting device according to claim 1, wherein
the first signal is a main signal, and
the second signal is a path trace signal superimposed as a frequency modulation component onto the main signal by controlling the frequency of the main signal, the path trace signal being a signal for confirming conductivity of an optical path on which the signal light is to be transferred.

5. An optical receiving device comprising:
a splitter configured to split signal light into first signal light and second signal light;
a first photodetector configured to receive the first signal light;
a light filter configured into which a pass-band center frequency and a transmission bandwidth are set so as to filter the second signal light;
a second photodetector configured to receive the second signal light filtered by the light filter; and
a control signal generator configured to generate a control signal based on a signal multiplied by outputs of the first photodetector and the second photodetector,
wherein the control signal generated by the control signal generator is transmitted to an optical transmitting device.

6. The optical receiving device according to claim 5,
wherein the pass-band center frequency is a frequency offset from a center frequency of the signal light, and
wherein the transmission bandwidth is a bandwidth at which the signal light partially permeates.

7. The optical receiving device according to claim 5,
wherein a power variation amount of the signal light is detected based on the output signal of the first photodetector,
wherein a symbol is detected based on the outputs of the first photodetector and the second photodetector, the symbol indicating whether or not a path trace signal superimposed as a frequency modulation component onto a main signal by controlling a frequency of the main signal is inverted in accordance with the power variation, the path trace signal being a signal for confirming conductivity of an optical path on which the signal light is to be transferred, and
wherein the control signal generator generates the control signal including the power variation amount of the signal light and the symbol.
